(19) United States
(12) Patent Application Publication
(10) Pub. No.: US 2025/0042290 A1
(43) Pub. Date: Feb. 6, 2025

(54) POWER OUTLET PROTECTION DEVICE

(71) Applicant: ECLEVER TECHNOLOGY GMBH, Dresden (DE)

(72) Inventor: Oliver Raguse, Bannewitz (DE)

(21) Appl. No.: 18/718,828

(22) PCT Filed: Dec. 12, 2022
(86) PCT No.: PCT/EP2022/085474

§ 371 Date: Jun. 12, 2024

(30) Foreign Application Priority Data
Dec. 12, 2021 (LU) LU500996

(51) Int. Cl. B60L 53/65; B60L 53/31; B60L 53/66; B60L 53/68; H01R 13/639

(52) U.S. Cl. CPC B60L 53/65; B60L 53/31; B60L 53/665; B60L 53/68; H01R 13/6397

(57) ABSTRACT

The invention relates to a power outlet protection device for authorized use of a power source, wherein the power source is connected to a device to be charged via a power conductor element, wherein the device comprises at least a authorization unit with which a user at a power source authorizes himself to use it, and wherein the power outlet protection device comprises a power source authorization unit and a power conductor authorization unit.

### TECHNICAL AREA

The invention relates to a power outlet protection device for the authorized use of a power source, wherein the power source is connected to a device to be charged via a power conductor element, wherein the power outlet protection device comprises at least a authorization unit with which a user authorizes himself to use a power source.

Further, the invention relates to a method for authorized use of a power source and a combination product for authorized use of a power source.

### STATE OF THE ART

A wide variety of plug-socket connections with different specifications are well known. Most consumers are familiar with the conventional safety sockets with the corresponding plugs. These are operated with a rated voltage of 230 V and may be fused with up to 16 A. This results in a maximum output of around 3.2 kW.

In particular, homeowners and campers are also familiar with so-called three-phase sockets or camping sockets in accordance with the international standard “Plugs, sockets and couplings for industrial applications” (IEC 60309). Depending on the design, these have rated voltages of up to 690 V (400 V is common in the normal consumer sector) and currents of up to 125 A (16 A or 32 A is common in the normal consumer sector). With the nominal voltages of 400 V and 32 A common in the normal consumer range, this results in an output of around 12.8 kW.

Until a few years ago, three-phase sockets in residential areas were usually only found in workshops or in yards, for example, to operate energy-intensive consumers such as circular table saws or similar. Three-phase sockets are also often located in underground garages to enable the operation of maintenance or cleaning machines, for example. However, it cannot be ruled out that a user of an electric vehicle will try to charge it at the three-phase socket, which is not intended for charging electric vehicles.

With the introduction of electric vehicles and the associated charging devices, such as charging stations and sockets, it has become necessary to provide a corresponding infrastructure to enable electric vehicles to be charged. In the meantime, such charging facilities can be found in many places, such as parking garages or underground garages of residential buildings, from which several dozen kilowatt hours can be taken, depending on the length of the parking garage stay.

Precautions had to be taken to protect the charging sockets from unauthorized use, i.e. to authorize only a certain group of users or devices to use the socket. For example, the gatekeepers of the parking garage were instructed to switch off the fuses to disconnect the socket from the electrical supply network so that it could then be manually released for use, for example by opening a cover covering the socket with a key.

Alternatively, locking systems are also known that can be operated by different users, for example by them having the same key. However, the disadvantage here must be mentioned that the doorman must be present and available, or all authorized users must have a key. Both options are also prone to errors, as it is possible to forget to switch the fuse off again after use or to lock the socket again.

Alternatively, charging stations have been designed with a card reader, whereby a user can authorize themselves to use the charging station with an authentication card (e.g. a key card or their credit card). The disadvantage of this is that a charging station must be equipped with a card reader, which is expensive and susceptible to counterfeiting. There are also known solutions that allow a user to authenticate themselves for use at a charging station via an application on their smartphone. However, these options require further manual processes in addition to plugging in the charging cable.

The U.S. Pat. No. 9,333,871 B2 describes a simple, fast and secure identification of a vehicle at a charging station, whereby technical elements such as a credit card reader can be dispensed with, so that no manual use of cards or typing in numbers is necessary. This is achieved by an identification unit (RFID tag) attached to or in the vehicle being recognized by the charging station. However, the object to be charged, in this case a vehicle, must be provided with a recognizable or readable specific RFID chip.

The EP 2 292 460 A2 discloses a possibility for fast, secure and cost-effective identification of a vehicle user, whereby the charging cable comprises a data storage element (e.g. in the form of an RFID chip). Identification information that can be read by the charging station is assigned to the data storage element. In addition, access to the socket of the charging station can be denied if authentication is missing and therefore rejected. In order to bring the socket into a staging position, EP 2 292 460 A3 suggests that the user must enter a PIN in addition to the required RFID chip of the charging cable at the charging station. It is also suggested that the user transmits the PIN via a mobile input device (e.g. smartphone). However, both processes require additional manual activity on the part of the user. Furthermore, EP 2 292 460 A3 suggests that the charging station should comprise a locking mechanism to prevent unauthorized removal of the charging cable. The data storage element can be exchanged and thus the identification of different customer accounts can be achieved. The data storage element can be designed as an RFID chip, so that the transmission of the identification information on the charging cable side does not require any additional power supply, as the readout takes place via a carrier signal emitted by the charging station. Furthermore, the data storage element can be connected to the charging cable so that it is inaccessible from the outside and cannot be detached, so that the charging cable can be assigned to a specific user and can only be used by that user

The WO 2020/097191 A1 discloses the use of near-field communication (NFC) by a mobile device (e.g. smartphone), or by an application, for authorization at a charging station.

The charging cables available for electric vehicles are often quite expensive products. In particular, if the charging cable and/or the charging station does not allow the charging cable to be locked to the vehicle and/or the charging station, an unauthorized third party can remove the charging cable and charge their own vehicle at the user's expense and then simply plug the connector back in. The authorized user does not notice this, or notices it until it is too late.

D The U.S. Pat. No. 8,736,225 B2 discloses a modularized interface (module) and a corresponding meth-od for flexible, secure and controlled connection of a plug-in vehicle (i.e. a hybrid or pure electric vehicle) to the energy grid. The modularized interface enables plug-in electric vehicles (hybrid or pure electric vehicles) to connect to the power grid in a way that allows vehicle owners to control their power consumption and the utilities companies to manage and meter the power loads of electric vehicles. Essentially, the interface is a module that is either portable or, for example, integrated into the vehicle's charging infrastructure. The module comprises a security authentication device for authenticating the user via, for example a password, or biometric capture. Using an identification code, the module can communicate with the provider, enabling an automatic billing process according to the amount of energy used. The module automatically interrupts the charging process if an unauthorized person gains access, thus preventing theft of electrical power, as no one other than the intended user can use the module. The module can also recognize the vehicle and provide the required current depending on its identity. The module can prevent unauthorized disconnection from the charging station by means of a corresponding mechanism (e.g. locking bolt). Via a communication interface comprising an antenna, the module can communicate via WiFi, ZigBee, WiMAX, satellite, RF or similar. The module also interacts with a smart socket to allow the corresponding identification and delivery of electrical power. The module can also be programmed to a new user.

The US 2009/192927 A1 discloses an electrical socket that can identify the user, control the power supply and monitor the power consumption. The power supply at the socket can be enabled for an authorized user whose power consumption can be tracked. The data assigned to a user can be stored and processed locally or remotely. A specific user can be charged a fee based on the power consumption data collected over time. The socket has systems for identifying the user, authorizing the user, controlling the electricity consumption and monitoring the electricity consumption. In addition, a method is disclosed which describes the billing of the electricity consumption for paying for the electricity directly or via an intermediary and for charging a consumption-based fee to the account. In order to activate the socket, a user can use an identification means (e.g. an identification card) to identify himself to a reader via a radio connection by transmitting an identification code stored on the identification card from the reader. An operator can manage the authorization list stored by the socket and used for the identification process and access electricity consumption data. The reader device comprises an RFID reader, wherein the user's identification card comprises a passive RFID tag which is read by the reader device. The socket communicates via a powerline-based network protocol (X. 10), WiFi or a hardwired network with a central computer on which a list of authorized uses is stored. The users are charged a fee based on the number of uses, the duration of use or the electricity consumption during use in accordance with an agreement made in advance.

The CN 1 259 693 A discloses a power interlock mechanism (mechanism) for a user's computer, wherein the mechanism helps prevent unauthorized access to the user's computer such that an unauthorized user is forced to at least remove or destroy the computer's housing in order to power the computer via a bypass. The power interlock mechanism comprises a physically operable lock and is coupled to a substantially fixed power input socket generally visible on the rear of most computers. The mechanism comprises a plug portion (switchable plug) which engages the power input socket of the computer by attaching a locking element, thereby becoming a plug locking portion comprising an intermediate portion containing a circuit and a recessed socket portion. The end of the power cable that was previously used to connect to the computer's power input socket is plugged into the recessed part of the socket. Basically, the installation of the mechanism consists of removing the plug of the computer power cord from the power input socket of the computer, inserting the plug part of the switchable plug into the power input socket and inserting the end of the power cord into the recessed socket part of the switchable plug. The plug part of the switchable plug has metal pins that are angled in such a way that they can be reliably embedded in the inner wall of a closed mains input socket. It is practically impossible to remove the plug part of the switchable plug from the mains input socket. The power locking mechanism can comprise a sensor that is designed, for example, as a card reader, biometric reader or as a unit that can be controlled via an electromagnetic connection and only releases the power connection after corresponding activation by a user. The electromagnetic signal can be an optical signal or a radio wave signal. In an embodiment, activation is possible via sound waves detected by the sensor. In addition, the current locking mechanism can comprise a programmable unit that can control the on or off state of the switchable plug.

The KR 101 871 272 B1 discloses a charging control device and a control method for controlling it. One function of the charging control device is to prevent an unauthorized person from interrupting the charging process. In addition, the charging control device allows a user who is physically distant from the charging control device to execute or release the lock between the charging control device and the vehicle using a mobile device (e.g. smartphone, smartwatch). Furthermore, a warning message is sent to the user's mobile device in the event of theft or suspected unauthorized use. It is further envisaged that a remote user can deactivate the charge control device using a mobile device if the charge control device is stolen. The charging control device comprises a communication unit for wireless communication (e.g. via WiFi, LTE). The identification of a vehicle is determined and compared with an internal list so that a locking mechanism is released depending on the position of the user's mobile device. The position/distance of the mobile device can be determined by the charging control device via a wireless connection. The user can be identified via a fingerprint scanner, a barcode/QR code scanner, a touch sensor, a microphone and an input unit with at least a keyboard and a camera. An NFC identifier is also provided.

The US 2014/0 191 718 A1 discloses a vehicle charging station with a power distribution interface, a receiver component and an authorization component for charging a vehicle. The receiver component of the charging station comprises an electromagnetic reader, such as an RFID reader, which can determine identification information of, for example, the vehicle authorized to charge at the vehicle charging station. In a disclosed embodiment, the “passing on” of authorization information is prevented in that the identification component cannot be transmitted to another vehicle and cannot be used to authorize the refueling of another vehicle. The system enables vehicle-based refueling services by subscription. Since a specific vehicle can be reliably identified, subscriptions for unlimited refueling within a certain period of time, for example, can be sold that correspond to the vehicle. This is possible because a maximum service and/or refueling usage can be calculated for the vehicle. The identification component can self-destruct when removed from the vehicle or delete the information stored on it, thus preventing misuse of the identification component by a third party.

The AT 508 853 B1 discloses a device for detecting and authorizing a current collector, in particular a plug on a power source with a socket, wherein the plug carries information for identification or authorization consisting of at least a computer chip, the information of which is transmitted optically or electronically when the plug is inserted into a socket by a readout device integrated in the socket, upon spatial approach or direct contact.

The device makes it easy to convert existing plugs by sticking the chip, for example an RFID chip integrated in a foil, into or onto the plug via an adhesive layer on one side of the foil. The information stored on the chip is compared with the information stored in a database and the user is either authorized or rejected. The information stored on the chip is read regularly during the charging time to ensure that only the authorized user is drawing energy from the pantograph. By removing the charging cable and thus the chip from the vicinity of the charging station reader, a notification can be sent to the user's cell phone.

The DE 10 2012 215 813 A1 discloses a method and a device for charging or discharging an energy storage device of an electric vehicle, wherein the method/device enables the user to be informed of the end of the charging process and thus does not have to spend any time at the charging device. When the charging process begins, the user receives a device (token) which displays the remaining charging time on a screen, for example. The duration of charging or discharging can be transmitted from the charging station to the token via a radio interface. The token comprises an RFID or NFC tag on which the corresponding information can be stored. This allows a specific charging station to be assigned to the token or the charging station currently assigned to the token to be specifically addressed. The token can be charged inductively so that no manual changing of batteries is necessary. After the vehicle has been connected to the charging station, the token is made available to the user of the charging station in a dispensing tray, for example, using a suitable mechanism. At the same time, the ID of the charging station is transmitted by radio to the token's memory. When the user removes the token from the output tray, the ID of the token is linked to the ID of the charging station and this information is stored on a central data storage device, e.g. a server, for later billing. At the same time, the charging station initiates communication with the vehicle and transmits the expected duration of the charging process to the token. The token displays this information on its screen. The token can also be used to display a notification if an attempt is made to steal the vehicle.

The type 2 plug (IEC 62196 type 2) for electric vehicles was developed to prevent the charging cable from disconnecting from the power source under load. This has two latches that electromechanically lock the plug to the vehicle. During the charging process, the plug is locked to the charging station so that it cannot be pulled out under load. The vehicle and charging station control the locking mechanism.

However, such a charging cable can still be used by an unauthorized third party if it is stolen by them while it is not connected to a charging station.

In addition, the designs of the charging cables commonly used for electric cars, such as a type 2 plug charging cable, are quite large, which is due on the one hand to electrotechnical requirements (e.g. conductor cross-section) and on the other hand to the requirements for theft protection.

Furthermore, it is not known how charging cables that are not intended for charging electric cars (e.g. charging cables for cell phones) can be secured against unauthorized use.

The prior art lacks a power conductor element (e.g. charging cable) that authorizes a user to use it and/or to use a power source, whereby the use can only be achieved by an authorized user or an authorized group of users.

### Objective

It is therefore the task of the present invention to provide a device with which a user can be authorized to use a power source and/or a power conductor element very easily and quickly with as little manual effort as possible.

### Solution

The task is fulfilled by a power outlet protection device with the features of claim 1. Further advantageous embodiments can be found in the subclaims, the description and the embodiment examples.

### General Advantages

With the present invention, a user can be quickly and easily identified, authenticated or authorized at a power source (e.g. charging station or inductive charging device).

Because the power conductor element (e.g. a charging cable) can only be explicitly assigned to a single user or a group of users, an unauthorized third party cannot do anything with a stolen power conductor element if it is marked to an authorized user.

Furthermore, the invention allows the user to start charging an energy storage device by simply plugging the power conductor element into a socket, whereby the charging power used can be billed automatically without the user having to provide, for example, his credit card number or an identifier.

A power source authorization unit makes expensive card readers or operating elements (e.g. a console) obsolete, which means that a charging station comprises fewer components, requires less maintenance and is cheaper to maintain.

Furthermore, a server-based or cloud-based authorization query at more than one charging station allows the creation of a user's movement and/or charging station usage profile, whereby the information obtained can be used for various purposes (e.g. better route planning, more efficient driving style, lower consumption). In addition, the power conductor element is not limited to use for electric vehicles.

Further advantages can be found in the description and the design examples.

### DETAILED DESCRIPTION OF THE INVENTION

The power outlet protection device according to the invention (also referred to herein as a power outlet protection system) enables authorized use of a power source with at least a socket. The power outlet protection device (SAV for short) comprises at least a power conductor element, which comprises at least a plug. In addition, the SAV may comprise a power source and at least a socket.

The invention relates to a power outlet protection device for authorized use of a power source with at least a socket comprising at least a power conductor element, wherein the device comprises at least a electronic and/or electromagnetic authorization unit by which at least a user can be authorized, wherein a power source authorization unit is arranged locally on and/or decentrally from the power source, and wherein the power conductor element comprises a power conductor authorization unit, and wherein the power conductor element is not designed as an integral component of the power source or is designed as an integral component of the power source, and wherein the power conductor element is assignable to a new user.

According to a particularly preferred embodiment, the socket protection system for authorized use of a power source comprises at least a power conductor element and at least a power source comprising at least a socket, wherein the power source comprises a power source authorization unit which is arranged locally on or decentrally from the power source, wherein the power conductor element comprises a power conductor authorization unit, wherein the power source authorization unit is adapted for authorization of at least an user by means of a galvanic connection (also: coupling) with the power source authorization unit.

The advantage of a galvanic connection is that it is more securely protected against tampering than a connection based on an electromagnetic connection (also: radio). Herein, a galvanic connection/coupling refers to the physical contact of two electrical conductors, in particular the conductors of the power conductor element authorization unit and power source authorization unit.

The power conductor element authorization unit and the power source authorization unit are both authorization units, the former comprising a power conductor element and the latter comprising a power source. The match of the matching of the power conductor element authorization unit with the power source authorization unit causes the power source, in particular the socket, to be enabled/disabled as described herein. By a match is meant here that the identification information which is stored on the power source authorization unit or a computing unit corresponds to the identification information which is stored on the power conductor element authorization unit (also: power source-specific authorization unit). The enabling/authorizing of the power source depending on the matching of the power source-specific authorization unit by the power source authorization unit and depending on the determined fill level can take place sequentially (i.e. one after the other) or simultaneously (i.e. at the same time).

According to a preferred embodiment, authorization to charge the device to be charged, in particular activation of the socket, is only enabled from a certain fill level. Preferably, the fill level is less than a comparison value of preferably 70%, particularly preferably 50%, and most preferably 30%, particularly 20%. The computing unit can preferably determine the fill level (charge level) of the devices to be charged, which are located near the power source and which the computing unit assumes want to carry out a charging process. Depending on the fill levels, the computing unit can authorize charging. According to a preferred embodiment, the power source and/or the power source authorization unit can determine the fill level of the devices to be charged, e.g. via the battery management system (BMS). For example, the computing unit can refuse authorization to a device to be charged that is already 70% full or not grant authorization at all as long as another device to be charged, which is only charged up to 20%, for example, is prioritized. Preferably, effective load management can thus be achieved for filling the devices to be charged.

In another embodiment, the user or the computing unit can specify or predetermine the value (also: comparison value) of the fill level that is used for prioritization. A user can do this, for example, via an app installed on a mobile communication device.

According to a further embodiment, authorization for charging the device to be charged, in particular enabling the socket, is only possible below a certain fill level. Preferably, the fill level is below 70%, particularly preferably below 50% and most preferably below 30%.

According to a preferred embodiment, the charging process of the device to be charged, in particular a release of the socket, is blocked above a certain fill level. Preferably, the fill level is greater than a comparison value of preferably 60%, particularly preferably 70% and very particularly preferably 80%. The computing unit can preferably determine the fill level (charging level) of the devices to be charged which are located in the vicinity of the power source and which the computing unit assumes want to carry out a charging process. Depending on the fill levels, the computing unit can authorize or block charging. According to a preferred embodiment, the power source and/or the power source authorization unit can determine the fill level of the devices to be charged, e.g. via the battery management system (BMS). Thus, the computing unit can, for example, refuse authorization to a device to be charged that is already 60% full or not grant it at all as long as another device to be charged, which is only charged up to 20%, for example, is prioritized. Preferably, effective load management can thus be achieved for filling the devices to be charged.

A power source comprises a power source of any configuration that is adapted to charge an energy storage device or to supply a load (e.g. indicators and/or brake lights and/or cooling unit of a trailer) with energy. The person skilled in the art is aware that a power source is also a voltage source. A power source comprises, for example, an electrical power supply network (e.g. low-voltage network) or a charging device (also: charging device, e.g. a charging station), such as those used for charging electric vehicles, whereby the charging device is connected to the electrical power supply network. According to the invention, however, a power source may also comprise a device that delivers a fossil energy carrier, in particular a fuel (e.g. diesel, gasoline, natural gas) and/or a renewable energy carrier (e.g. hydrogen) to an energy storage device or a consumer. Accordingly, a power source can also comprise a gas supply network, which can also be adapted to carry compressed air. Furthermore, a power source can also be adapted to exchange information technology data.

Herein, a socket (also: power source socket) is understood to be a device connected to the power source, through which an electric current and/or a fossil energy carrier and/or a renewable energy carrier can be taken from the power source or derived from it. A socket can therefore be designed, for example, as a device with (at least single-phase) electrical contacts and/or as a valve for dispensing a fossil fuel or a renewable energy source.

Furthermore, a socket may also comprise an element adapted to charge an energy storage device by induction. Such a device is referred to herein as an inductive charging field (also: inductive charging device). The skilled person is familiar with such devices. For example, coil devices embedded in the ground are known, which charge the battery of an electric vehicle when it is parked over a coil device. Furthermore, coil devices can also be installed in the road surface of highways, for example.

The power source and the device to be charged (e.g. electric vehicle) can be a component of a charging system, i.e. comprising the charging system. The charging system may further comprise a means for determining the fill level, which detects the fill level of a device to be charged.

According to an embodiment, the power source is designed as an inductive charging field. With an inductive charging field, it is advantageous that the vehicle or the device to be charged can be charged without contact.

An energy storage device (also: accumulator) comprises a device that is suitable for storing electrical or chemical energy. Electrical energy storage devices comprise, for example, accumulators in electric vehicles and mobile communication devices (e.g. smartphones, tablets). Chemical energy storage comprises devices that are adapted to store a fossil fuel or a renewable energy source. For example, a chemical energy storage system comprises gasoline, diesel, natural gas and hydrogen tanks installed in vehicles. The terms “electric vehicle” and “vehicle” are used interchangeably in this document. Filling the energy storage system is referred to as a charging process (also: charging, loading, filling).

In this context, a power conductor element is an electrically conductive device that connects a power source to an energy storage device and/or a consumer (e.g. electric motor, combustion engine, compressed air motor). In a preferred embodiment, the power conductor element is designed as an at least single-phase cable. It goes without saying that, if the power conductor element discharges a fossil energy carrier and/or a renewable energy carrier from the power source, the power conductor element is designed such that a fluid connection is provided between the socket and the energy storage device. In this case, the power conductor element is referred to as a fluid conductor element because a fluid (fuel) is transported through it. Accordingly, the terms power conductor element and fluid conductor element are used equivalently herein.

In a preferred embodiment, the power conductor element comprises at least a plug, which is adapted to derive electrical energy and/or a fossil fuel and/or a renewable energy source from the power source. A plug is operatively connected to a socket for this purpose. Preferably, the power conductor element comprises two plugs which are arranged opposite one another and are to be referred to herein as power source plug and charging plug, the former being connectable to the socket of the power source and the latter being connectable to an energy storage device or consumer. A large number of plugs (also: plug connections, plug types) are known from the state of the art. By way of example, but not limited to these, the following are mentioned here: Three-phase plugs, CEE plugs, IEC plugs, USB plugs, tank nipples (e.g. TN1 CNG), valves.

In the event that an inductive charging field is used to charge the energy storage device, a plug is not necessarily comprised by the power conductor element, but can still be comprised by it if the energy storage device is to be charged via induction on the one hand and via a galvanic connection to the power source on the other. The power conductor element is preferably arranged as a coil (also: secondary coil) on the underside of the vehicle body for energy transmission from an inductive charging field, but can also be located at another position on the vehicle.

Under authorized use of a power source is understood herein that a user (also: customer, end consumer) can only draw an electric current and/or a fossil fuel and/or a renewable energy source from the power source if he is authorized to do so. Authorization can be granted, for example, by a service provider (also: provider). It is known from the state of the art that the authorization is granted, for example, via chip cards, credit cards, smartphone applications, which is disadvantageous for the reasons mentioned above. Herein, the terms authorization and authentication are used equivalently. For the purposes of the invention, a user also comprises a technical device (e.g. trailer, cleaning device, robot).

In an embodiment, a trailer which is towed by a towing vehicle (truck, railroad) should only be usable if prior authorization has been granted. In particular, it may be desired that the lighting and/or braking means comprising the trailer can only be used if the trailer has been authorized for use beforehand. This can be done, for example, by connecting a power conductor element (e.g. a power source plug) included in the trailer to the socket of the towing vehicle pulling the trailer. Authorization thus takes place via a galvanic coupling. Alternatively, one of the authorization options described below, as well as combinations thereof, may also apply. For example, a charging cable, or a power conductor element authorization unit comprised by it, which is described below, can be authorized via a cloud by plugging it into the socket.

In a further embodiment, a load comprises a trailer with a refrigeration unit or another electrical load. Such trailers are known to be supplied with power either via the tractor and/or via a socket not comprising the tow vehicle. Preferably, the electrical load can only be supplied with energy if it is authorized to do so as defined herein. In this way, the use of the trailer or another electrical consumer can be advantageously restricted to a specific user or user group.

In order to authorize a user to use the power source by means of the power outlet protection device according to the invention, the provider can provide the power conductor element with an identifier (e.g. a numerical or alphanumerical value). There may be various providers who provide the user with a power conductor element provided with a corresponding identifier, which enables the user to use a power source. The power conductor element can also comprise a user ID assigned by the provider. The power source is provided by a power supply company, for example.

An identifier provided by the provider and/or user can be connected to the power conductor element, which emits the amount of energy requested by the user depending on the identifier. Advantageously, an identifier means that different providers/users have access to the same power source, or that the user can be authorized to use different power sources that are not all assigned to the same provider. In this way, uniformity and simpler operation of the power sources can be achieved, as the user can use any power source and is not limited to those of one provider. Instead of different providers setting up and operating differently designed power sources, this task can be placed under the responsibility of, for example, an energy supplier or the public sector (e.g. the Federal Network Agency). The user can then choose the provider, analogous to today's telecommunications network, which authorizes the user to purchase a certain amount of energy within a certain period of time.

Based on the above, there is an advantageous reduction in the costs of maintaining a power source (e.g. charging station) infrastructure, whereby the lower costs can be passed on to a user.

In the spirit of the invention, such a power conductor element can comprise a charging cable for a mobile terminal device, whereby the user can only use it on selected power sources. In this way, for example, stores (e.g. restaurants) can prevent any user from charging their smartphone without asking for the store's services. Instead, the business (in this case the provider) can only assign an identifier if it intends to authorize the user to use the power source.

In a preferred embodiment, the device according to the invention comprises at least a electronic and/or electromagnetic authorization unit (also: authorization unit), by means of which at least an user or a group of users can be authorized, i.e. is authorized to use the power source on the basis of the action of the authorization unit. The authorization unit comprises a power source authorization unit and a power conductor element authorization unit. An authorization unit may be implemented as an interconnection of electronic components and/or as a computer program product, or may be designed as an interconnection of electronic components that communicates with a computer program product. Herein, an electronic and/or electromagnetic design of the authorization unit is understood to mean that it implements the authorization process by means of an electronic (galvanic) connection or an electromagnetic connection (e.g. via radio), as described below, and preferably does not use a mechanical connection (e.g. key-lock) for authorization, which advantageously eliminates the need for manual action by a user.

A power source authorization unit (SQAE) refers to an authorization unit that makes the power source identifiable (also: recognizable). An SQAE is preferably designed to identify a power conductor element and/or user.

In an embodiment, the SQAE is arranged locally on a power source, which means, for example, that it is comprising the housing of the power source (e.g. a charging station). Advantageously, this means that a user can be authorized directly at the power source without having to transmit the data required for an authorization query to the provider to a system, which on the one hand advantageously reduces data traffic and on the other hand makes authorization independent of a data transmission network (also: communication network), such as a mobile phone network, which makes authorization possible even if the data transmission network is not functional.

In a further development, the SQAE is arranged at least partially or completely decentralized from the power source, whereby a decentralized position describes a spatial arrangement that is not congruent with the position of the power source. For example, the SQAE can be located at the provider's location, which is several kilometers away from a charging station. Furthermore, the SQAE can also be located on a server, a computer or in a cloud. This can advantageously prevent, for example, unauthorized manipulation of the SQAE by a person pretending to be a user (also: unauthorized user).

In an alternative embodiment, the SQAE is located in the user's living area, for example. It may be desirable that the user is only authorized to use the power source once he has entered the living area. For example, the user may be the owner of an electric vehicle, which they park in a parking space in the underground garage of a residential building. As soon as the user has not left the home for more than 15 minutes, for example, the SQAE can assume that the electric vehicle will not be moved for a longer period of time and can therefore be charged advantageously without interruption, which has a positive effect on the durability of the battery installed in the electric vehicle.

Furthermore advantageously, the safety of the user or other persons can be increased if the power source delivers a fossil fuel or a renewable energy source (e.g. hydrogen). As the user is preferably not in the vicinity of the vehicle to be charged at the time of delivery, their safety is increased.

In order to determine whether a vehicle will not be moved for a longer period of time, an artificial intelligence (AI) can be used which, for example, monitors when the user usually leaves their living space to move their vehicle or calculates when the user is likely to need their vehicle. The AI is preferably designed to communicate with an authorization unit.

According to an embodiment, the AI or an algorithm is adapted to create a movement and/or power source usage profile (also: power source usage profile) of a user or the device to be charged (e.g. vehicle), whereby the information obtained can be used for various purposes (e.g. better route planning, more efficient driving style, lower consumption), advantageously resulting in a higher efficiency of vehicle use.

The charging period and the position of the charging process can be determined by a computing unit. The computing unit can also determine the movement profile of a user or vehicle. The computing unit can use this information to determine a movement or charging station usage profile of a user or vehicle.

The position information can be determined by the computing unit, for example, via the mobile communication device or via the power source authorization unit.

By incorporating the movement and/or power source usage profile of the device to be charged, users or vehicles can advantageously be prioritized over others and the order of charging can be adjusted.

In an embodiment, a temporal distribution of the charging power to the unit(s) to be charged is effected as a function of the movement and/or power source usage profile, in particular as a function of the power source usage profile.

In an embodiment, the user is authorized by being in close proximity to the power source. An authorization to use the power source can be obtained, for example, by the user communicating with the SQAE via the activated Bluetooth function of his smartphone and an application on the smartphone. This advantageously means that the user does not have to do anything other than insert the plug into the socket of the power source. Furthermore, there is the advantage that an unauthorized user cannot use the same power source because he is not authorized to use it, as he does not have the Bluetooth identification of the user authorized to use it.

In a particularly preferred embodiment, a power conductor element comprises a power conductor element authorization unit (SEAE). The SEAE is preferably arranged on or in the power source connector and/or on or in the charging connector of the power conductor element. An SEAE is preferably used to identify the power conductor element. In this way, a large number of power conductor elements can be advantageously individualized and assigned to a specific user. For example, a provider can assign a charging cable to a user, with which the user can be authorized to use a power source.

The power conductor element authorization unit is also referred to herein as a power source-specific authorization unit.

In a particularly preferred embodiment, the SQAE and the SEAE are designed for mutual identification (also: recognition). This means, for example, that the SQAE can detect the presence of an SEAE and/or the SEAE can detect the presence of an SQAE. Furthermore, the SQAE and the SEAE can be adapted to communicate with each other so that data can be exchanged advantageously between them.

The power conductor element is preferably not designed as an integral component of the power source. This means that the power conductor element can be reversibly connected to the power source. The advantage of this is that the power conductor element can be transported by a user to another power source.

According to a preferred embodiment, the power conductor element is designed as an integral component of the device to be charged and is preferably integrated into it.

According to a preferred embodiment, switching of the socket can be realized by the power source authorization unit and/or a power conductor element authorization unit, wherein the advantages specified below are achieved by switching.

According to an embodiment, switching comprises either enabling and/or disabling the socket.

In an embodiment, an authorization unit, preferably an SQAE, can cause the socket to switch. Switching is understood herein to mean that the socket is disconnected from the power supply network and/or from the gas supply network (switching off), so that an unauthorized user cannot use the power source, and/or that the socket is disconnected from the power supply network or the gas supply network as soon as the charging process of the energy storage device has ended. The power conductor element connected to the socket can therefore no longer carry electricity and/or fossil fuels and/or renewable energy sources. Furthermore, switching also comprises the opposite process, i.e. when the socket is connected to the energy supply network and/or the gas supply network (unlocking), so that the power conductor element connected to the socket enables an electrical current and/or a fossil energy carrier and/or a renewable energy carrier to be drawn for charging an energy storage device or for operating a consumer.

According to an embodiment, the switching of the socket can be realized by at least an electromagnetic unit. This is described below.

B Preferably, the socket is switched by at least an electromechanical unit. In this context, an electromechanical unit is understood to be a device that is controlled by an electrical signal or a signal sequence in order to cause the socket to be disconnected and/or switched off. Preferably, the electromechanical unit can be controlled by an authorization unit, e.g. an SQAE, in order to effect activation and/or deactivation. Further preferably, the electromechanical unit is comprising the power source. For example, the electromechanical unit can be installed within a charging station.

The electromechanical unit is preferably designed in such a way that it is controlled via a control circuit and causes the socket to be enabled and/or disabled via a charging circuit (also: working circuit, main circuit). This means that the electric current and/or fossil fuel and/or renewable energy source and/or compressed air taken from the power source can be taken via the charging circuit.

According to an embodiment, the electromechanical unit comprises at least a relay and/or a current impulse switch and/or a transistor switch, which are described below.

Common electromechanical units for activating and/or deactivating a charging circuit comprise, for example, relays, impulse switches and transistor switches. Preferably, a current impulse switch is used for switching according to the invention, as this advantageously has a lower energy consumption than a relay or transistor switch. It goes without saying that an electromechanical unit for switching a socket of a power source from which a fossil energy carrier and/or a renewable energy carrier and/or compressed air and/or a fluid (e.g. water) can be drawn must be designed in such a way that the electromechanical unit can, for example, open a valve or the like.

A transistor switch can be used, for example, for power sources where only small currents (under 5 A) flow within the charging circuit. Such charging circuits are suitable for charging mobile communication devices, for example, but not for charging electric vehicles. Advantageously, a transistor switch enables the socket of a power source that does not have space for a relay or impulse switch to be switched. This can also advantageously result in a simpler design that is subject to less or no mechanical wear due to the lack of mechanical parts. For electric vehicles, for example, insulated gate bipolar transistors (IGBT) can be used, which are designed for much higher voltages and currents that are suitable for charging an electric vehicle.

The device according to the invention comprises at least an identification module which can be controlled by an authorization unit, preferably an SQAE, or can control it. An identification module according to the invention is adapted to make user identification executable and comprises, for example, a console with or without a display for entering a personal identification number (PIN), a fingerprint sensor and/or a biometric sensor (e.g. for voice recognition, iris scan). Especially with the use of the latter, a simple authorization of a user is advantageously made possible, as the user does not have to remember a PIN. In this context, controllability or control means that a device, unit, module or appliance can communicate with another device, unit, module or appliance, with communication (e.g. via mobile radio) preferably taking place in both directions. In principle, activation comprises an exchange of data, whereby activation results in switching, for example.

According to a preferred embodiment, the device according to the invention comprises at least an identification module which is controllable by the power source authorization unit and/or the power conductor element authorization unit.

An identification module can also comprise a device that is adapted to use parts of the electromagnetic spectrum not visible to humans for signal transmission for identification. Such a device comprises, for example, Bluetooth, WLAN, 2G (GPRS, EDGE), 3G (3G, H, H+), 4G (LTE, LTE-A), 5G, 6G, LoRaWAN, RFID, NFC, UMTS, LTE, ZigBee, WiMax and other mobile radio standards, or a combination of at least one of the above, as identification means (also: radio connection). A combination advantageously means that it is not limited to a mobile radio standard.

According to a particularly preferred embodiment, the identification module comprises an NFC connection and/or an RFID connection as identification means, which advantageously results in a cost-effective type of identification or authorization that can be operated without an internal power supply, which is not the case, for example, with active radio modules such as WLAN or Bluetooth.

An embodiment is designed in such a way that a user connects a power conductor element to the energy storage device and the socket of a power source (e.g. charging station for electric vehicles), whereby the power conductor element comprises an SEAE and the power source comprises an SQAE. The user can be authorized by this connection alone.

An additional authorization function is preferably adapted so that the user can advantageously only start the charging process when they want to and/or no unauthorized user can unauthorizedly authorize charging by stealing the charging cable. This is designed, for example, in such a way that the user carries their smartphone with an activated Bluetooth function (or another wireless connection). The charging process is only enabled when the SQAE recognizes the user's power conductor element and their smartphone (e.g. via a Bluetooth identifier).

In a further development, an identification module can be designed in such a way that parts of the electromagnetic spectrum visible to humans are used as a means of identification. For example, the SQAE can communicate with an application installed on the smartphone, which generates a QR code on the display that the user actively holds up to a scanner at the charging station to start the charging process. Advantageously, this means that the user does not have to enter a PIN or take any other action (e.g. by pressing a button) to start the charging process. It is also advantageous that a charging station can be designed in such a way that it does not comprise a control panel that could get dirty. Dispensing with a control panel also allows a charging station to be produced and maintained more cost-effectively.

In an alternative embodiment, a control panel for operating a charging station (e.g. for selecting different charging capacities) can be projected onto the display of the user's smartphone as soon as the user has authorized himself at the power source by plugging in the power conductor element.

In an embodiment, the SEAE and/or the SQAE is adapted for user-side detection. This means, for example, that the power conductor element is designed in such a way that it can identify the user's vehicle as soon as it is connected to the user's energy storage device. This advantageously means that an additional authorization level can be adapted. For example, a power conductor element could only be used in connection with a specific vehicle. Especially when filling up with fossil fuels (e.g. petrol, diesel), it can happen that a user fills up with the wrong fuel, resulting in engine damage. Therefore, consumer-side detection by the SEAE or the SQAE is advantageously used to cut off the fuel supply to the energy storage system at the socket if the user wants to fill up with the wrong fuel.

In an embodiment, an identification means comprises an RFID connection and/or an NFC connection. The skilled person is familiar with how both connections are established to enable communication between two units, e.g. a SQAE and a SEAE. RFID systems comprise a reader (reader with antenna) and a transponder (tag), whereby the transponder can be comprised of a charging cable in order to make it identifiable to an SQAE. An RFID chip can be used to store the user ID in order to authorize a user at a power source by an SQAE, which can read the data stored on the RFID chip. If a user is to be denied authorization, e.g. to use a charging station, the SQAE can, for example, withdraw authorization from the individual RFID identifier of this user on a server.

In a particularly preferred embodiment, an NFC connection is selected to identify a power source and/or a power conductor element and/or an energy storage device by means of an SEAE and/or an SQAE. The advantage of an NFC connection is that the data stored on the NFC chip can be rewritten. For example, an SQAE can change the data stored on an NFC chip of a charging cable. In this way, it is advantageously possible to store on the charging cable NFC chip at which power sources (e.g. charging stations) when and/or for how long and/or with which charging current the charging cable has charged the energy storage device. Furthermore, a charging cable can advantageously be assigned to a new user by the SQAE, for example, so that the old user or an unauthorized third party cannot or can no longer authorize themselves with the charging cable at a power source. Another advantage of using an NFC connection is that an authorization request does not first have to be transmitted to a server, for example, but can be made directly at a charging station, for example, and is therefore independent of a possible server failure or failure of an Internet connection or other mobile phone connection used to transmit the data. Data traffic is also advantageously reduced.

The skilled person knows that an NFC connection is based on the technology of an RFID connection. This defines an NFC chip as rewritable, whereas the RFID chip is not.

In a preferred embodiment, a plug, preferably the power source plug, comprises at least a NFC chip and/or a RFID chip (also: transponder, tag) for establishing an NFC connection and/or establishing an RFID connection.

According to an embodiment, the plug is adapted to an identification determination, namely a neutral identification, and/or positive identification, and/or negative identification, as described below, by an identification module and/or an identification means.

Preferably, the identification of a power conductor element (e.g. a charging cable) is determined by an SQAE. An identification determination (also: authorization query) can result in a negative identification, and/or a neutral identification, and/or a positive identification. A negative identification denies the user or unauthorized user the use of the power source, whereas a positive identification allows it. Neutral identification may or may not have no consequences. Which state occurs can be specified by the SQAE.

According to an embodiment, the SQAE causes the socket to be switched depending on the identification determination. For example, the socket can be switched off with a negative identification and switched on with a positive identification, so that electrical energy can be drawn from the socket.

Preferably, a positive and/or negative authorization of the plug, or an SEAE, can be transmitted to an SQAE, whereby the transmission can be carried out via common transmission methods known to the person skilled in the art (e.g. fibre optic line, mobile radio). Accordingly, the power source has a communication interface adapted for transmission.

According to an embodiment, switching, in particular enabling and/or disabling, is dependent on a time period. This advantageously means that a user does not have to be on site, i.e. at the power source, to start or stop the charging process. Preferably, the time period is specified by a user and/or an algorithm and/or artificial intelligence.

It may be desirable for switching to be dependent on a time period. For example, the SQAE could specify the time periods or for how long a user is authorized to use a power source or how long they are allowed to draw power from the power source. For example, it could be that a user has only paid for a certain quota. If he charges beyond this, i.e. for longer, he will be charged for the additional consumption. However, this has the disadvantage that the provider must first make an advance payment and only receives the corresponding remuneration for the additional service later. Advantageously, time-dependent switching gives the provider better control over how long a user uses the power source.

In an embodiment, a charging cable comprises a SEAE (e.g. with NFC chip), on which is stored how long the charging cable may use the power source for charging.

In a preferred embodiment, a billing process can be initiated by activating the socket. The SQAE can initiate this. Advantageously, the user does not have to make an effort to initiate this himself, but this happens automatically, for example, by simply connecting the energy storage device or the load to the power source via the power conductor element. A billing process is designed, for example, by the provider in such a way that it regulates what the user must pay for an amount of electricity drawn and/or a fossil fuel and/or a renewable energy source.

According to an embodiment, a notification to a control unit can be initiated by a rejected authorization.

According to an embodiment, the billing process can be initiated by the control unit.

A refused authorization by a user, in particular an unauthorized user, can result in a notification to a control unit. A control unit is understood to be, for example, a warning light or a warning tone signal transmitter, which informs an unauthorized third party acoustically and/or visually of a lack of authorization. In addition, a control unit in the form of process steps can also be comprised of a computer program product, whereby this transmits a message to the unauthorized user's smartphone, for example, in order to offer him a payment process that authorizes him to use the power source.

According to a preferred embodiment, an unintended disconnection of the power conductor element triggers a notification to the control unit.

In an embodiment, an unintentional disconnection of the power conductor element leads to a notification to the control unit. An unintentional disconnection is understood to be a process that causes the power conductor element to be disconnected from the power source and/or the energy storage device without this being intended by the user. This concerns, for example, an attempted theft of the power conductor element by a third party or an attempted use of the power conductor element by the third party. The control unit is adapted so that the user receives a notification (e.g. on a mobile communication device such as a smartphone). This allows the user to visit the vehicle to be charged as quickly as possible in order to stop the process. This can advantageously counteract theft of the power conductor element or unlawful use of a power source by an unauthorized third party.

According to an embodiment, a connection can be established between the power source authorization unit (SQAE) and at least a mobile communication device and/or at least a computing unit.

Preferably, a connection can be established between the SQAE and a mobile communication device and/or a computing unit. A mobile communication device comprises, for example, smartphones, tablets, notebooks, transponders and all devices carried by a user that are designed for communication, in particular mobile radio and/or Internet communication. In this context, a computing unit is understood to mean a device comprising at least a processor. A computing unit thus comprises, for example, an electrical circuit, a computer, a server, a cloud, a display console or another system on which at least a computer program product (also: software) can be executed. A connection can be established, for example, via at least a electrical conductor, optical fiber or mobile radio. A connection is used to transmit data, in particular data of an information technology structure.

In an embodiment, the SQAE performs an identification query at regular intervals. This can be done, for example, by the SQAE checking whether the power conductor element is still connected to the power source. This can advantageously ensure that the energy storage device is still connected to the power source. Otherwise, the SQAE can switch it off and, for example, send a notification to the user via the control unit. The time intervals can be selected so that they are smaller than 60 min, preferably smaller than 30 min, particularly preferably smaller than 10 min, very preferably smaller than 1 min, further preferably smaller than 30 s, further particularly preferably smaller than 1 s, further particularly preferably smaller than 500 ms and further preferably smaller than 100 ms. The advantage of a smaller selected time interval is that the SQAE can switch off the socket more quickly, which increases the safety of the user, especially if a fossil fuel and/or a renewable energy source (e.g. hydrogen) is used to charge the energy storage system.

In an embodiment, the SQAE can be taught online and/or offline to a power conductor element, in particular its SEAE. In this context, training means that an SQAE can be confronted with a new power conductor element so that it is recognized as authorized for use. This can be done online if an SQAE is located decentrally on a server or in a cloud and/or offline if the SQAE is located locally at or in the power source (e.g. a charging station). To initiate the training process, an authorized person (e.g. an employee of the provider) can, for example, press a button on the power source or enter a PIN and have the SQAE detect the new power conductor element to be detected during or after this process. The provider can also authorize a user to train a charging cable on a power source by communicating a one-time valid PIN. This advantageously enables very simple authorization. It may also be possible for a user to authorize another user to use the power conductor element and/or a power source.

An embodiment provides that manual disconnection of the power conductor element from the socket of the power source and/or the vehicle is not possible without authorization. This can be achieved, for example, by requiring a user to enter a PIN before disconnecting or to authorize themselves in another way (as described above). This advantageously means that no unauthorized user can interrupt a charging process, e.g. to take a fossil fuel from the power source without authorization. Disconnection can be made possible, for example, by activating a current impulse switch from the SQAE to release a mechanical connection established before charging by means of an electromechanical safety device (e.g. a safety bolt, a lock, a latch) to enable disconnection.

According to a further embodiment, it is not possible to disconnect the power conductor element from the socket and/or the vehicle without authorization. This advantageously prevents unintentional disconnection of the power conductor element from the socket.

In a further development, the power source can only be used when a mobile communication device (e.g. smartphone, transponder) and the SEAE are simultaneously in the immediate vicinity of the power source (e.g. charging station). Immediate proximity describes a position of 100 m or less, preferably 20 m or less, particularly preferably 5 m or less and most preferably 2 m or less. Preferably, the mobile communication device sends a detection (also: ping, identification), e.g. via a Bluetooth connection. The SQAE detects this and tests whether the SEAE is also in the immediate vicinity. If both are present, the SQAE authorizes the user to use the power source.

In an alternative embodiment, the socket is covered by a gate when it is not in use. Preferably, the gate is made of a stable material (e.g. metal, metal compound, composite material). It is further preferred that the edges of the gate are designed in such a way that it can only be opened (broken open) with considerable mechanical effort and/or force. In a preferred embodiment, the power source is essentially cylindrical in shape, with the gate being designed as a rotating cylinder (gate cylinder) within the power source. The socket is located inside the cylinder and is only accessible to the user when the door cylinder has rotated into an opening position after authorization. Turning the door cylinder to the opening position can also make a control panel and/or a display accessible, provided that the power source comprises one.

A power source can essentially be designed as a stable, cylindrical column with a smooth metal surface and is thus advantageously better protected against damage or weather influences than the charging stations known from the prior art. Preferably, a power source designed in this way does not have a point of attack for tools such as crowbars. The person skilled in the art is aware that the charging station must be designed in such a way that it is still accessible to maintenance personnel. This can be achieved, for example, via a contactless radio connection as described above.

According to a preferred embodiment, the power source can only be used when a mobile communication device and the power source authorization unit are simultaneously in the immediate vicinity of the power source. In particular, the power source is only caused to emit electrical power when the power source authorization unit and a mobile communication device are located in the immediate vicinity of less than 10 meters around the power source. In this way, it is advantageously possible to ensure that only the owner of the mobile communication device can draw electrical power from the power source.

In an alternative embodiment, the power conductor element can only be used when it is in the immediate vicinity of a user. For this purpose, the SEAE can be designed in such a way that, if it is connected to a power source, it tests the environment at periodic intervals (e.g. every 2 minutes) for the presence of a mobile communication device (e.g. smartphone, transponder) with an active radio connection (e.g. active Bluetooth) of the user. If this is present, the SEAE allows the power conductor element to be used. This advantageously results in a further security function and restriction to a specific user.

A further development of the power conductor element is that it comprises an additional safety function. This is designed in such a way that mechanical severing or other damage to the power conductor element connected to a power source results in a notification being sent to the control unit and the user being informed of this (e.g. via their smartphone). In addition, the power conductor element can comprise a visual and/or acoustic warning function (e.g. alarm light, alarm sound). To enable the power conductor element or the SEAE to register damage, temperature sensors can be fitted in the outer sheath of the power conductor element to register thermal damage. In order to register mechanical damage/severing, metal threads can be arranged in the outer sheath of the power conductor element, for example, the severing of which triggers the notification and/or the warning function.

According to an embodiment, the power conductor element comprises at least a sensor that is adapted to detect mechanical severing of the power conductor element (e.g. in the event of vandalism). The sensor preferably has at least a sensor element, which is extended at least in sections, but preferably over the entire length of the power conductor element.

The sensor can, for example, comprise at least a metal thread, the severing of which triggers a notification, in particular a notification to the power source, a provider, a user, or another unit described herein (e.g. SQAE, computing unit) in order to inform them of a severing of the power conductor element. Preferably at least a metal thread, preferably at least two metal threads are arranged along the power conductor element and preferably comprising the material of the outer sheath of the power conductor element. Cutting at least a of the metal threads preferably causes an immediate shutdown of the socket. This advantageously increases the safety of persons (including the persons responsible for the severing) who are in the vicinity of the power source, as the power supply is already interrupted even if none of the current-carrying conductors have been severed. It is clear to the person skilled in the art that the metal thread itself must carry a current, the interruption of which, caused by a severing of the power conductor element, leads to an activity of the sensor. Instead of at least a metal thread, at least a glass fiber can also be adapted for this function.

According to an embodiment, the power source and/or the power source authorization unit registers the approach of an object to be charged.

In a further embodiment, the power source is designed as an inductive charging field and is capable of registering the approach of an object to be charged (e.g. an electric vehicle). In order to register an approach, the device can, for example, comprising an optical distance sensor (e.g. LIDAR, RADAR, ultrasonic sensor) and/or a weight sensor (e.g. piezo element), with which the device, in particular the inductive charging field, registers occupancy by a vehicle. The power source and/or the SQAE can send a query, preferably via a radio link, to the SEAE to perform a user authorization.

According to an embodiment, charging of an energy storage device is enabled by the power conductor element authorization unit (SEAE).

In a further development, the charging of the energy storage device is essentially determined by the SEAE. If an inductive charging field is part of a road (e.g. freeway), i.e. the energy storage device should preferably be charged while the vehicle is moving, then a way is also required here to enable simple and fast authorization of the user. The SEAE, which in this embodiment is comprising the vehicle, could detect that the vehicle is located above an inductive charging field. The inductive charging field laid on the road may comprise SQAEs at regular intervals that communicate with the SEAE and inform it of the identity of the power source. Alternatively, the inductive charging field may comprise a specific charging frequency that is specific to the section of road being traveled.

The SEAE then checks (e.g. via a wireless connection to a decentralized server of the provider) whether the user is authorized to use the power source for charging and then activates the charging process after positive identification and initiates a billing process if necessary. In this example, it is therefore not a socket on the power source side that is activated by the SQAE. Instead, the charging process is activated on the energy storage system side. This has the advantage that no SQAE is required. It goes without saying that a vehicle manufacturer must design an energy storage system in such a way that it can only be charged via the action of the SEAE, so that an unauthorized third party can also be prevented from using the inductive charging field.

In a further development, position transponders, which can comprise an SQAE, can be installed at intervals along the routes traveled, which inform the vehicle and/or the SQAE, for example, about the route sections traveled, in particular the kilometers traveled.

In a further development, the inductive charging field can provide an Internet connection option so that a vehicle, in particular the SEAE and/or a user's mobile communication device, can access the Internet even in areas with poor mobile phone coverage.

In an embodiment, an adapter is connected between the socket and the power conductor element. An adapter can comprise an SQAE and is considered to be comprised by the power conductor element. Preferably, the adapter is designed so that different power conductor elements (e.g. with different power source plugs) can be connected to the adapter. In this way, it is advantageously possible to use power conductor elements from different countries that use different socket standards. Authorization to use the power source can then be granted via the adapter or via the SEAE comprising it.

In a further development, the adapter can, for example, communicate electrically via the power conductor element with the battery management system (BMS) or another device of an electric vehicle. Herein, the adapter can be adapted so that it either records vehicle data (e.g. battery status, driving times, standstill times, driving style, charging processes, charging currents) or retrieves it from a storage element and transmits it to a decentralized computing unit (e.g. a server, cloud) and/or to a mobile communication device. Communication with the decentralized computing unit can also preferably serve to authorize the user.

In an embodiment, the power conductor element is adapted in such a way that the charging history is stored on it, in particular on a memory unit comprising the power conductor element. In this way, for example, the location, charging voltage, temperatures and charging cycles can be stored on the storage unit. This advantageously makes it possible to track how often the power conductor element has been in use. For example, its wear can be estimated.

According to another embodiment, a power conductor element is marked in color, with the color marking corresponding to the maximum charging power that can be drawn from the power source. For example, it is conceivable that a user is handed a blue-marked power conductor element by an issuing point, with which the user is authorized to draw a defined amount of energy from a charging station. This amount of energy can be stored as a quota on a storage unit comprising the power conductor element. The user may have already paid for the quota before charging. With each charging cycle, the charging power taken from the power source is deducted from the quota. If the quota is used up, the power conductor element must be provided with a new quota by the issuing point. This advantageously means that the withdrawal of charging power can be controlled even if no decentralized point (provider) that manages the power source is connected to the power source. This further saves data traffic and is particularly advantageous in rural areas with poor network coverage. Of course, in this case it must be ensured that a color-coded power conductor element is only compatible with the corresponding power source and can draw power from it.

According to a preferred embodiment, the device according to the invention is adapted to send a message to a user's mobile communication device in order to inform the user about the status of the charging process, in particular its remaining time.

According to an embodiment, the power conductor element has an identifier that can be recognized by a mobile communication device. This identifier is preferably not visible in the power conductor element. The identifier can be read out via an application installed on the mobile communication device (e.g. smartphone). This advantageously makes it possible to identify a power conductor element belonging to a specific user. The identifier can be transmitted, for example, via transmission paths based on electromagnetic properties as described herein.

In a further embodiment, a handle by which a user grips the power conductor element comprises a disinfectant. This is adapted to reduce the number of germs on the handle, which can advantageously ensure that germs, in particular pathogens, are not transmitted to subsequent users.

A disinfectant can, for example, be designed in such a way that at least a blue light-generating means (e.g. blue light LED) is arranged in the handle in such a way that the handle surface is illuminated by the blue light. As an alternative or in addition to blue light, other parts of the electromagnetic spectrum may also be considered. The skilled person is aware of areas of the electromagnetic spectrum that have a damaging effect on microorganisms and/or proteins. Blue light, for example, is known to be effective in killing microorganisms in the wavelength range of 400 to 450 nanometers (nm). This works via the absorption of blue light by biomolecules (so-called porphyrins), which are omnipresent in living cells. In the presence of oxygen, these biomolecules, which are energetically stimulated by the blue light, form oxygen radicals in a chemical reaction which, due to their high reactivity, lead to cell damage, the prevention of reproduction or the killing of microorganisms.

According to an embodiment, the power conductor element and/or the power source has a mechanism which is adapted to eject the power conductor element, in particular to eject the plug (power source plug, charging plug), wherein the ejection can be controlled from a computing unit which is spatially remote from the power conductor element.

In addition, the invention relates to a power conductor element which is adapted for authorization at a socket and has the properties disclosed herein.

Furthermore, the invention relates to a method for the authorized use of a power source with at least a socket, comprising the steps of authorizing a user and/or power conductor element by at least an authorization unit, switching the socket by a power source authorization unit and/or a power conductor element authorization unit depending on the identification determination, initiating a billing process by the power source authorization unit and/or the power conductor element authorization unit and/or the control unit, establishing a connection between the power source authorization unit and at least a communication device and/or a computing unit.

According to an embodiment of the method, the power source authorization unit recognizes the power conductor element authorization unit and/or both authorization units communicate with each other.

According to an embodiment, training of the power source authorization unit to a new power conductor element is carried out online and/or offline.

According to an embodiment, the method comprises the automatic generation of a movement and/or charging station usage profile (also: power source usage profile) of at least an user, in particular of at least a vehicle, further in particular of a fleet of vehicles, authorizing a user and/or a power conductor element by at least a authorization unit (power source authorization unit and/or power conductor element authorization unit), determining a charging usage period and a position of the charging process by a computing unit, in particular by an algorithm and/or artificial intelligence running on the computing unit, creating a movement profile of the user and/or the vehicle and creating a charging station usage profile using the data obtained relating to the charging usage period, the position of the charging process and the movement profile of the user and/or vehicle by a computing unit or an algorithm and/or artificial intelligence running on the latter.

The charging station usage profile provided by the method advantageously allows the user to suggest a more economical driving style and/or a more economical use of the power sources. In addition, the method can be used to manage the charging station usage times of a vehicle fleet. For example, a car rental company can implement the method to determine which vehicle is in use when, when it is expected to be returned and when, where and for how long it is expected to be charged.

Further, the invention relates to a computer program product comprising commands which, when the program is executed by a computer, cause the computer to perform the above-mentioned method steps.

The invention also relates to a computer-readable (storage) medium on which at least the computer program product can be stored.

Furthermore, the invention relates to a data processing device (computer) comprising at least a computer-readable (storage) medium.

According to an embodiment, the data processing device (computer) forms a network with other computers.

The invention also relates to a data carrier signal which transmits the computer program product.

Furthermore, the invention relates to a combination product for authorized use of a power source with at least a socket comprising a power source, a socket, a power conductor element, a power source authorization unit, a power conductor element authorization unit, wherein the combination product is produced by connecting the power conductor element to the power source, wherein the power source authorization unit is designed to be communicable with and/or recognizable as the power conductor element authorization unit.

Furthermore, the invention relates to the use of the device according to the invention (power outlet protection device) or the combination product for the authorized use of a power source with at least a socket, wherein the use of the device or the combination product is directed to charging a communication device and/or a vehicle.

A data processing device according to the invention can be structured in such a way that it forms a network with other data processing devices. For example, a network can be designed as a server, a cloud, an Internet or LAN. In a preferred embodiment, the SQAE is decentralized and located in a cloud, wherein it is obvious that only parts of the SQAE may be comprised by a cloud or a computer program product, which do not comprise the components necessary for the physical identification of e.g. a power conductor element. Advantageously, such a decentralized localization of the SQAE means that only the provider has access to it and a third party (assuming appropriate protection such as a firewall) cannot manipulate the SQAE.

Depending on specific implementation requirements, embodiments of the invention may be implemented in hardware or in software. The implementation may be performed using a digital storage medium, for example a floppy disk, a DVD, a Blu-Ray disc, a CD, a ROM, a PROM, an EPROM, an EEPROM or a FLASH memory, a hard disk or other magnetic or optical memory, on which electronically readable control signals are stored that can or do interact with a programmable hardware component in such a way that the respective method is performed.

A computing unit can be formed by a processor, a computer processor (CPU=Central Processing Unit), a graphics processor (GPU=Graphics Processing Unit), a computer, a computer system, an application-specific integrated circuit (ASIC=Application-Specific Integrated Circuit), an integrated circuit (IC=Integrated Circuit), a single-chip system (SOC=System on Chip), a programmable logic element or a field-programmable gate array with a microprocessor (FPGA=Field Programmable Gate Array).

In general, embodiments of the present invention may be implemented as a program, firmware, computer program or computer program product comprising a program code or data, wherein the program code or data is effective to perform one of the methods when the program is executed on a processor or programmable hardware component. The program code or data may, for example, also be stored on a machine-readable carrier or data carrier. The program code or data may be in the form of source code, machine code, byte code or other intermediate code.

### DESIGN EXAMPLES

The present invention is explained in more detail with reference to the following embodiments, without limiting the invention to these.

A preferred embodiment comprises a power source designed as a charging station for electric vehicles (e.g. a passenger car). The user who wishes to use the charging station to charge the battery of the electric vehicle connects the electric vehicle to the charging station via the charging cable. The power source plug of the charging cable comprises an NFC module as SEAE comprising an NFC chip. The user ID of the user is encoded on this. When the charging station is plugged into the socket, it registers the presence of the charging cable via an NFC module, whereby the local SQAE comprising the charging station communicates with a database via an Internet connection and compares the user ID with the data in the database, whereby the database is managed by a provider, for example. In this way, the user is authorized to charge at this charging station or his access to use the charging station is denied. If authorization is positive, the SQAE activates the socket.

During the charging process, the power source plug is non-detachably connected to the charging station by the user via an electromechanical fuse such as a locking pin when used as intended (without significant force). The SQAE encodes on the NFC chip how long the user has been charging their electric vehicle and at what power. Once the charging process is complete, the socket is switched off and the power source plug can be disconnected from the socket again.

The described embodiment of the invention is to be understood as exemplary and not limiting. The invention can also be implemented in other ways. For example, the charging station can communicate with an application on the user's smartphone. This allows the charging station to tell the user how long the charging process is expected to take. This information is determined by means of an algorithm or an AI, whereby the information is determined using the charging process history information stored on the NFC module of the charging cable in order to predict the duration of a charging process. This advantageously means that the user does not have to be in the immediate vicinity of the vehicle. If the user wants to interrupt the charging process before it is finished, they can do so by transmitting the command to the charging station via the application on the smartphone, which authorizes the disconnection of the charging cable. Furthermore, any interruption of the charging process by the SQAE that is not intended by the user is transmitted to the application so that the user is informed of this process immediately.

The foregoing is only preferred and realizable embodiments of the present invention. Therefore, any equivalent structural modifications made by applying the description of the invention are to be included in the scope of the patent application.

The skilled person will recognize that variations and modifications may be made without departing from the true scope of the invention as defined by the claims and description. It is therefore intended to include within the scope of the invention all variations and modifications that fall within the scope of the appended claims and equivalents thereof.

1-22. (canceled)

23. A method for authorized use of a power source by a device to be charged, comprising the following steps:
(S01) Bringing into contact of the power source, in particular a charging station, with the device to be charged, in particular an electric vehicle via a power conductor element,
wherein the power source comprises a power source authorization unit by which at least the device to be charged is authorized,
wherein the device to be charged comprises a power source-specific authorization unit,
wherein a metal thread is arranged along the power conductor element, wherein the metal thread is comprised by a material of an outer sheath of the power conductor element,
and wherein the metal thread is adapted such that a severing of the metal thread causes an immediate shutdown of the power source,
(S02) Matching of the power source-specific authorization unit by the power source authorization unit,
(S03) Enabling/authorizing the device to be charged by the power source authorization unit, if the matching of the power source-specific authorization unit by the power source authorization unit results in a match,
(S04) Establishing a conductive connection between the power source and the device to be charged, thereby initiating a charging process at the device to be charged,
notification to a control unit and an user if the power conductor element is mechanically severed or damaged in any other way.

24. The method according to claim 23, wherein the power source and the device to be charged are components of a charging system.

25. The method according to claim 23, wherein the step of enabling/authorizing (S03) the power source further requires:
(i) Determining a fill level of the device to be charged by a means for determining the fill level,
(ii) Comparing the determined fill level of the device to be charged with a first predetermined comparison value, and
(iii) if the determined fill level is lower than a first predetermined comparison value: disconnection of the power source by the power source authorization unit.

26. The method according to claim 23, wherein a step of blocking the power source is provided, which requires the following:
(i) Determining the fill level of the device to be charged
(ii) Comparing the determined fill level of the device to be charged with a first predetermined comparison value, and
(iii) if the determined fill level is greater than a second predetermined comparison value: blocking of the power source by the power source authorization unit.

27. The method according to claim 23, further comprising a further device to be charged contacted with the power source, the charging process being set as a function of the determined fill levels of both devices to be charged.

28. The method according to claim 23, wherein prior to the step of enabling/authorizing (S03) the power source, a movement and/or a power source usage profile of the device to be charged is included.

29. The method according to claim 23, further comprising initiating a billing process by the power source authorization unit and/or the power source-specific authorization unit after completion of the charging process.

30. The method according to claim 23, further comprising a temporal distribution of the charging power to the unit(s) to be charged as a function of the movement and/or the power source usage profile.

31. The method according to claim 23, further comprising a temporal distribution of the charging load at the power source depending on a power source utilization profile and/or a number of devices to be charged contacted with the power source.

32. The method according to claim 23, wherein a training of the power source authorization unit to a new device to be charged is performed online and/or offline.

33. A power source securing system for authorized use of the power source, comprising
a power source comprising the power source authorization unit by which at least the device to be charged is authorized,
the device to be charged, and
at least the power conductor element comprising the power source-specific authorization unit,
wherein the power conductor element authorization unit is arranged for enabling/authorizing at least the device to be charged at the power source authorization unit,
characterized in that
the power conductor element has an outer sheath and in that
the power conductor element has a sensor,
wherein the sensor comprises the metal thread,
wherein the metal thread is comprised by the material of the outer sheath and
wherein the severing of the metal thread triggers the notification to the power source or the user or a provider.

34. The power source securing system according to claim 33, further comprising the device to be charged, in particular an electric vehicle.

35. The power source securing system according to claim 33, wherein the power source comprises at least the socket.

36. The power source securing system according to claim 33, wherein the power conductor element authorization unit is adapted to authorize at least the user by means of a galvanic connection with the power source authorization unit.

37. The power source securing system according to claim 33, wherein the power conductor element comprises at least the sensor adapted to detect mechanical severing of the power conductor element.

38. The power source securing system according to claim 33, wherein the device to be charged comprises the means for determining the fill level of the device to be charged, and wherein the means for determining the fill level is directly or indirectly coupled to the power source authorization unit.

39. The power source securing system according to claim 33, wherein the power source-specific authorization unit and/or the power source authorization unit codes for the delivery of a defined amount of energy to the device to be landed.

40. The power source securing system according to claim 33, wherein the power source and the device to be charged are connected to each other via the power conductor element, wherein the power source-specific authorization unit is arranged on the power conductor element preferably at the point of contact with the power source.

41. The power source securing system according to claim 33, wherein furthermore an information technology unit, in particular a mobile communication device, such as a smartphone, tablet, notebook, is provided, which is adapted such that it is connected to the power source authorization unit.
